(19) United States
(12) Patent Application Publication
(10) Pub. No.: US 2007/0202895 A1
(43) Pub. Date: Aug. 30, 2007

(54) SMS notification of called party availability

(76) Inventors: David S. Benco, Winfield, IL (US); Paresh Kanabar, Naperville, IL (US); John C. Nguyen, Naperville, IL (US); Huixian Song, Naperville, IL (US)

Correspondence Address: Richard J. Minnich, Esq.;Fay, Sharpe, Fagan, Minnich & McKee, LLP, 1100 Superior Avenue, Seventh Floor, Cleveland, OH, 44114-2579, US

(21) Appl. No.: 11/362,895

(22) Filed: Feb. 27, 2006

(51) Int. Cl. H04Q 7/20

(52) U.S. Cl. 455/466

(57) ABSTRACT

Methods and systems are presented for notifying a previously unsuccessful mobile calling party of a mobile called party's availability, in which a home location register causes an announcement to be sent to the unsuccessful calling party indicating that the called party is currently unavailable and that the calling party will be sent a short message when the called party becomes available. The called party status is then monitored and once the called mobile becomes idle or active, the HLR facilitates, utilizing a short message service center, sending a short message to the caller indicating that the called party is available to receive a call.

### FIELD OF THE INVENTION

This invention relates generally to the field of telecommunication systems, and more particularly to wireless communications systems and methods for notifying a calling party of a called party availability using short messaging.

### BACKGROUND OF THE INVENTION

Wireless communications has become a major part of everyday life, allowing people to communicate with one another regardless of current location. The capability to communicate to or from any given location itself is a tremendous advantage, and wireless customers may also select from an array of useful ancillary services to augment the advantages of mobile telecommunications, including call waiting, voicemail, short messaging capabilities, etc. In conventional wireless networks, however, a calling party may attempt to call another wireless customer, only to find that the called party is unavailable. For example, the called party may be on another call (busy), or the called mobile unit may be powered down or out or range of radio communications infrastructure or otherwise unable to receive the call. Although voicemail services provide for one-way communication in these circumstances, allowing the caller to record information that can be retrieved later by the called party, voicemail may not expedite actual two-way vocal communication between the parties, and provides only a partial solution, particularly where the purpose for the call was time sensitive. In this situation, when a caller finds that the called wireless customer is unavailable, the calling party may simply forego leaving a message on voicemail, and simply hang up and retry the call attempt later, often requiring several attempts before the call is finally completed or until the caller gives up. These unsuccessful intermediate attempts may also cost the caller in terms of plan minutes and may also expend battery power. Furthermore, these uncompleted call-back attempts expend system resources, for which the service provider may not make any profit. Moreover, between such call-back tries, the called party may actually be available for a time, and then receive or place another call before the original calling party again unsuccessfully attempts a call. This problem has led to the development of certain services in which a so-called “call server” or other additional external network server provides an indication to the mobile calling party when the called party is idle after completing a call. However, this approach requires additional network equipment and additional messaging in the network. Thus, there is a need for improved systems and methods for notifying a previously unsuccessful mobile calling party of a mobile called party's availability.

### SUMMARY OF THE INVENTION

The following is a summary of one or more aspects of the invention to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The various aspects of the present invention relate to services to notify a subscriber calling party by short messaging when a previously unavailable called party becomes available to receive a call, utilizing existing equipment without the need for additional network servers or messaging.

In accordance with one or more aspects of the invention, methods are provided for notifying a previously unsuccessful mobile calling party of a mobile called party's availability. The methods include monitoring the availability status of a mobile called party user equipment using a mobile switching center (MSC) or other mobile network switching element and notifying an associated home location register (HLR) that the called user equipment has become available. The HLR causes a short message to be sent to the calling party user equipment notifying the calling party that the previously unavailable called party user equipment is available to receive a call. This allows the subscriber caller to avoid unnecessary call-back attempts while the called party is busy, inactive, or otherwise unavailable, and then to resume call attempts precisely at the appropriate time, thereby enhancing the chances of completing a call while limiting the number of unnecessary (and unsuccessful) call-backs. In certain embodiments, when the initial unsuccessful call attempt is made, the called party home location register may send an announcement to affirmatively notify the calling party that the called party user equipment is currently unavailable and that a short message will be sent when the called party becomes available, thereby ensuring that the caller knows the service is operating.

Further aspects of the invention relate to mobile communications systems and calling party notification systems thereof, in which an unsuccessful calling party is notified by short messaging that a called party is available for receiving a call. The systems include a short message service center (SMSC) operatively associated with a mobile calling party to provide short messages to a mobile calling party user equipment, as well as an MSC or other mobile switching element and an HLR operatively associated with a mobile called party user equipment. The mobile switching element is operative to check the availability status of the mobile called party user equipment and the home location register receives an indication from the switching element that the previously unavailable mobile called party user equipment has become available to receive a call. The home location register uses the short message service center to initiate a short message to the calling party user equipment to notify the calling party that the previously unavailable mobile called party user equipment has become available.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1 is a system level diagram illustrating a telecommunications network with a system for notifying wireless customers of a called party's availability via short messaging in accordance with one or more aspects of the present invention;

FIGS. 2A and 2B provide a call flow diagram illustrating an exemplary SMS notification to previously unsuccessful callers when a called mobile user equipment becomes idle from busy; and

FIGS. 3A and 3B provide a call flow diagram illustrating an exemplary SMS notification to previously unsuccessful callers when a called mobile user equipment becomes active from inactive.

### DETAILED DESCRIPTION OF THE INVENTION

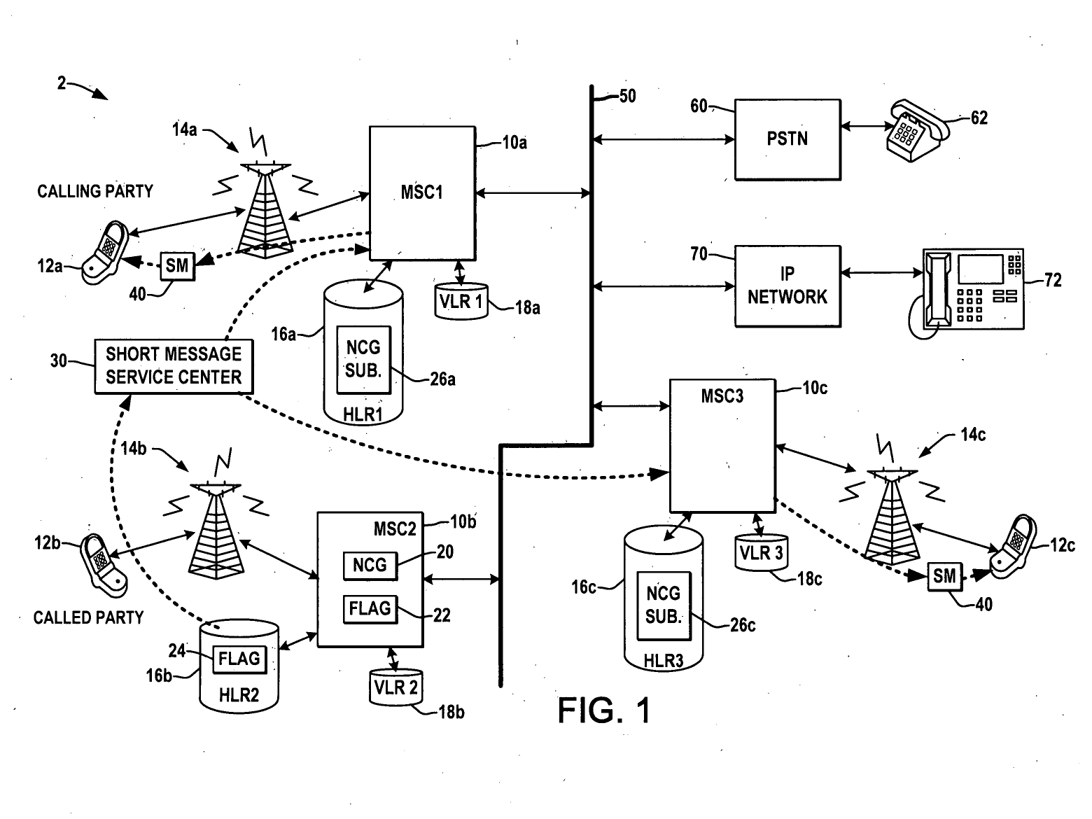

Referring now to the figures, several embodiments or implementations of the various aspects of the present invention are hereinafter illustrated and described in conjunction with the drawings, wherein like reference numerals are used to refer to like elements. FIG. 1 shows an exemplary communications system 2 in which various aspects of the invention may be carried out to provide a short message notice to a calling party that a called party has become available. The system 2 includes a network 50 providing operative communicative connection of various communications devices and network elements allowing various telephones, mobile units, computers, digital assistants, etc. to communicate with one another for exchange or transfer of voice, short text messages, and/or data or other information therebetween. In particular, calls may be placed between calling and called parties using various wireless and/or land-line user equipment (UE) 12, 62, 72 which are operatively coupled with call control elements and one or more networks 50, 60, 70 formed by operative interconnection of various network elements including mobile switching centers (MSCs) 10 as are known, wherein three exemplary MSCs 10a-10c are illustrated in FIG. 1. The communications system 2 can in general include any type or types of communications networks and network elements, including but not limited to a Public Switched Telephone Network (PSTN) 60 for communication with one or more land-line telephones 62, mobile networks for communicating via mobile user equipment 12, IP-networks 70 for communications using VoIP phones 72, computers, or other IP-based devices, and combinations thereof, wherein the various network elements are operatively associated with one another to allow communications therebetween and therethrough with respect to data and control signaling or messaging.

In the example of FIG. 1, moreover, the mobile communications elements include various MSC type mobile switching or call control elements 10 for performing normal switching and call control functions for mobile calls to and from other telephone and data systems, with associated Home Location Registers (HLRs) 16 and Visitor Location Registers (VLRs) 18, where the HLRs 16 in general provide a database used for storage and management of customer subscriptions and service profiles to facilitate routing calls to and from indicated subscribers, and the VLRs 18 provide a database storage and access functionality with respect to temporary information about roaming subscribers such that the MSCs 10 can service visiting mobile units. In general, the switching elements 10, and HLRs 16, etc. can be any suitable hardware, software, combinations thereof, etc., which are operatively coupled with the network 50 to provide call service functionality as is known, including but not limited to routing and control functions, as well as the calling party notification functionality illustrated and described further herein, without the need for additional network elements such as “call servers”, etc.

The switching elements 10, HLRs 16, and the functionality thereof may be implemented in integrated entities or may be distributed across two or more entities in the system 2, for instance, where the elements 10 and 16 may themselves be integrated with one another or separate. The exemplary MSCs, moreover, 10 preferably include memory and processing elements (not shown) for storing and executing software routines for processing and switching calls as well as for providing various call features to calling or called parties, and further provide for the availability status monitoring and notification functionality described herein. The switching elements 10 are generally operative with any suitable circuit, cell, or packet switching and routing technologies, including but not limited to Internet Protocol (IP) and Asynchronous Transfer Mode (ATM) technologies, etc., and are operatively interconnected by bearer and control traffic links (not shown) to accommodate exchange or transfer of bearer traffic (e.g., voice, video, or image data, etc.) as well as control traffic (e.g., inter-node signaling in accordance with SS7 ISDN User Part (ISUP) or SIP protocols, etc.), respectively, wherein such links may be logical links implemented, for example, as T1 carrier, optical fiber, ATM links, wireless links, and the like.

The MSCs 10 are interoperable with various forms of mobile user equipment 12, wherein three exemplary SMS enabled wireless phones 14a, 14b, and 14c are shown in FIG. 1 for ease of illustrating the various aspects of the invention. With respect to the system 2 as a whole, any form of user equipment 12 may interface with the system 2 via MSCs 10 and networks 50, 60, 70 for placing or receiving calls, for example, wireline or Plain-Old-Telephone-Service (POTS) phones 62 communicating via the PSTN 60, mobile communication devices such as mobile phones 12 and/or personal digital assistants (PDAs), pagers, computers with wireless interfaces, or other wireless devices communicating via one or more of the MSCs 10, and IP-based devices, such as computers, VoIP phones 72, etc. interacting via the IP network 70. The operative coupling of the wireless mobile phone user equipment 12 with the MSCs 10 may be of any suitable form, for example, including base station system (BSS) equipment 14 providing radio-related functions, where the BSSs 14 preferably comprise base station controllers (BSCs) and base transceiver stations (BTSs), schematically illustrated in FIG. 1, to transfer voice and data traffic between the mobile stations 12 and the MSCs 10.

In the illustrated system 2, a first mobile switching element 10a is the home MSC for a calling party subscriber associated with the mobile 12a discussed in the examples below, and the MSC 10a is operatively coupled with the network 50 to provide communications service to any number of wireless units including the exemplary first mobile calling party user equipment 12a. The MSC 10a is operatively coupled with a first home location register 16a that stores subscription information relating to the mobile calling party user equipment 12a, where the subscription information includes an NCG subscriber indicator 26a indicating that the user equipment 12a subscribes to a calling part notification service, referred to herein as NotifyCallinG party or NCG service. A VLR 18a is also provided, to facilitate the MSC 10a providing communications services to roaming wireless devices.

A second MSC 10b is also operatively coupled with the network 50 to provide communications service to a called mobile user equipment 12b using base station system 14b, HLR 16b, and VLR 18b, wherein MSC 10b is currently serving user equipment 12b and may, but need not be, the home MSC for mobile 12b. The called party serving MSC 10b is operable to monitor the availability status of mobile 12b in order to determine whether the mobile 12b is available to receive a call and includes calling party notification (NCG) functionality 20 as described herein, along with a flag 22 indicating that mobile 12b is to be monitored for a transition from busy to idle, from inactive to active, or otherwise from unavailable to available. Likewise, HLR 16b includes a flag 24 indicating that the called party mobile 12b is the subject of the herein-described calling party notification services.

Another exemplary MSC 10c is shown in the system 2, coupled with an HLR 16c, a VLR 18c, and a BSS 14c for servicing a mobile 12c, wherein the illustrated third mobile device 12c is also a subscriber to the NCG services and is SMS enabled to receive short messages via a suitable SMSC. The third HLR 16c in this case includes an NCG subscription indicator 26c indicating whether mobile 12c subscribes to the calling party notification service.

The system 2 also includes one or more short message service centers (SMSC) 30, one of which is illustrated in FIG. 1 for sake of illustration, wherein the HLRs 16 and MSCs 10 are operatively coupled with the short message service center 30. The SMSC 30 is adapted to send short messages 40 to the calling party mobile 12a via the serving MSC 10a and base station system 14a, and may likewise send short messages to the third mobile 12c via MSC 10c and BSS 14c. In this manner, the called party HLR 16b in particular, and other network entities may send short messages to the calling party user equipment 12a and 12c for calling party notification or other reasons in the system 2. The SMSC 30 provides for relaying and store-and forwarding of such short messages 40 between the HLR short message entity 16b and the mobiles 12a, 12c as discussed in the embodiments below, wherein the exemplary SMSC 30 is implemented as a stand-alone network element. The calling party mobiles 12a and 12c in the following examples are wireless user equipment capable of receiving and originating short messages as well as voice calls, wherein the wireless signaling infrastructure is based on Signaling System No. 7 (SS7), and the short messaging services employ the mobile application part (MAP) defining methods and mechanisms of communication in wireless networks using SS7 transaction capabilities application part (TCAP) service. An SMS service layer makes use of the MAP signaling capabilities and enables the transfer of short messages between the peer entities. With respect to short messages 40 sent to the user equipment 12a served by MSC 10a and HLR 16a, the SMSC 30 interrogates the HLR 16a, which in turn provides the routing information for the mobile 12a, and similar operation is provided with respect to mobile 12c via HLR 16c and MSC 10c.

For calling party subscribers 12a, 12c to the service, if the called mobile 12b is unavailable (e.g., busy or powered off), the caller will be provided with an announcement indicating that the called subscriber is busy or powered off and that the NCG service will send a short message when the called party becomes available. Once the called mobile (e.g., 12b in this example) becomes idle (from busy) or becomes active (from powered off), a mobile terminated short message 40 is sent to the caller(s), indicating that the called mobile 12b is idle/active now. The NCG service, moreover, is provided using existing network equipment, such as HLRs 16, MSCs 10, a unified subscriber database such as a Super Distributed Home Location Register (S(D)HLR), etc., without additional network elements and extra messaging.

In operation, the calling party's home MSC 10a provides the calling party's NCG service information to the called party's HLR 16b to indicate a call that is from an NCG subscriber, and the called party's serving MSC (MSC 10b in this case) tracks the availability status of the called user equipment 12b (e.g., busy, idle, powered-on, power-off). The HLR 16b keeps a list of any subscriber calling parties awaiting the availability of the called mobile 12b, and also sends an initial NCG announcement to the caller when the first call attempt is unsuccessful. The caller's HLRs 16a, 16c support NCG service data provisioning for the callers, and pass a NCG service indication to a VLR of a visited MSC when the NCG subscriber roams. Thus, whereas the callers 12a, 12c are located in their respective home MSCs 10a, 10c in the examples below, in other cases where a calling subscriber is registered in a serving MSC 10 (roaming), the NCG service indication will be passed from the home HLR 16 to the S-MSCNLR via its profile. When this subscriber makes a call to a busy or inactive (powered off) subscriber, the NCG service indication will be passed to the called party's HLR 16b, for instance, using in an MSC-HLR interface message, and the HLR 16b will mark the record associated with this called subscriber 12b indicating that a NCG call is made to this subscriber and also records the calling party's number. In addition, the called party HLR 16b instructs the called party's serving MSC 10b to track the called mobile's status and for each such call attempt stores the calling party and called party numbers. Once the called mobile 12b becomes available, the called party HLR 16b notifies the SMSC 30 to send a short message 40 to the subscriber callers that had earlier tried to call the called mobile 12b but were unable to connect because the called user equipment was busy or inactive.

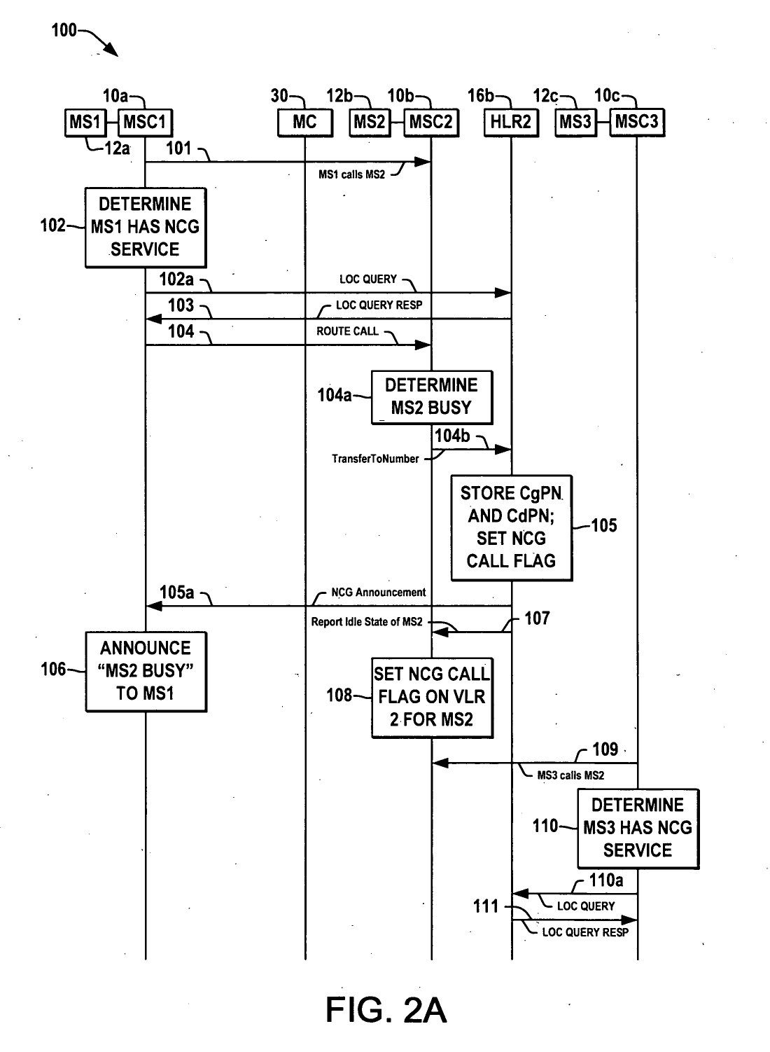

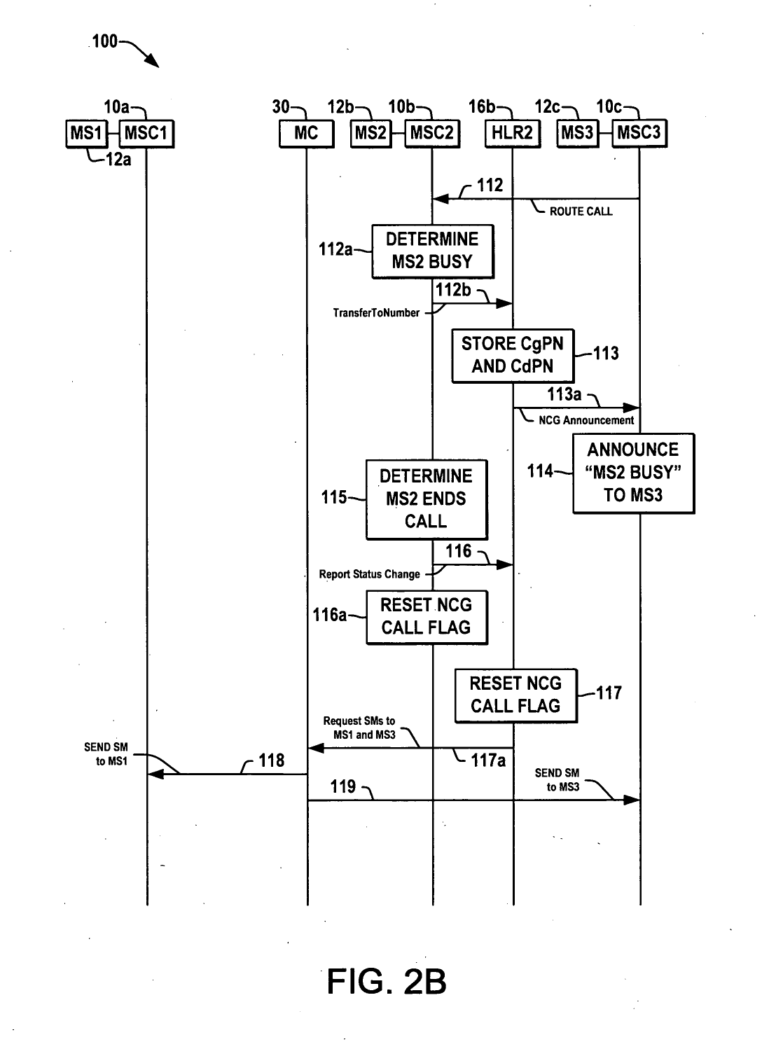

Referring also to FIGS. 2A and 2B, operation of the system 2 is described hereinafter using a call flow diagram 100 to illustrate one or more caller notification features in accordance with the present invention, wherein the illustrated example involves calls by calling party user equipment 12a and 12c to a busy called party user equipment 12b, with both the exemplary callers 12a and 12c being subscribers to the calling party notification (NCG) service. A first mobile calling party user equipment (mobile station MS1 12a in FIGS. 2A and 2B) tries to call a called party user equipment (MS2 12b) at 101, which in this example, is busy and therefore unavailable to receive the attempted call. The serving called party MSC 10b (MSC2 in FIGS. 2A and 2B) determines at 102 that the unsuccessful caller MS1 12a has subscribed to the NCG service (indicated by a flag or other indicator 26a in HLR 16a), and sends this information to the busy called party's HLR2 16b in a location query message at 102a. In response, the called party HLR2 16b sends a location query response message at 103 to MSC1 10a, including location information for the called party mobile 12b.

The calling party MSC1 10a routes the call to MSC2 10b at 104, whereupon the MSC 10b determines at 104a that the called party user equipment MS2 12b is busy, and sends a busy indication at 104b to the called party HLR2 16b, such as in a TransferToNumber message of termination trigger for Busy operation in the ANSI 41 standard. At 105, the HLR2 16b notes that the caller MS1 12a was attempting to call MS2 12b, and stores the calling party number (CgPN) and the called party number (CdPN). In addition, HLR2 16b sets an NCG call flag 24 (FIG. 1) at 105 for the called party MS2 12b (if not already set), and responds at 105a to the caller's MSC1 10a with a message indicating that MS2 12b is busy, and providing an NCG service announcement (or instructions to MSC1 10a to send an announcement) indicating to the caller at 106 that the called party 12b is unavailable and that they will be sent a short message when MS2 12b again becomes available to receive calls. The HLR 16b then requests at 107 that the called party home MSC2 10b monitor the status of the called mobile 12b and report to the HLR 16b when the mobile 12b becomes available to receive a call. The called party MSC2 10b then sets its own NCG call flag 22, which may be sent to the corresponding VLR if MS2 12b is roaming.

This situation may continue for as long as MS2 12b remains busy or otherwise unavailable. In order to further illustrate the exemplary NCG features, another prospective caller MS3 12c attempts to call the busy mobile 12b at 109. In this case, the additional caller MS3 12c is also an NCG subscriber, as determined by the corresponding home MSC3 10c at 110, which then sends this information to the called party HLR2 16b in a location query message 110a. At 111, the HLR2 16b sends a location query response to the new caller's MSC3 10c, including the location information for the called mobile 12b. Turning also to FIG. 2B, the MSC3 10c then routes the call to MSC2 10b via a route call message 112, whereupon MSC2 10b determines at 112a that MS2 12b is (still) busy and MSC2 10b sends a busy indication to HLR2 16b at 112b (e.g., TransferToNumber message). For this new unsuccessful caller 12c, the HLR2 16b records the calling and called party numbers (CgPN and CdPN, respectively) at 113, and responds to MSC3 10c at 113a with a message including an MS2 busy status and providing or otherwise initiating an NCG announcement. The calling party MSC3 10c then plays the announcement to the caller 12c at 114, indicating that MS2 12b is busy and that a short message will be sent when MS2 12b becomes available.

When MS2 12b eventually ends the current call, MSC2 10b detects the change in the availability status at 115. At this point, MSC2 10b reports the status change to the HLR2 16b at 116 and resets it's NCG flag 22 (FIG. 1) for MS2 12b at 116a. The called party HLR 16b also resets it's NCG flag 24 at 117, and sends one or more messages at 117a to the short message center SMSC 30, causing SMSC 30 to send short messages (e.g., message 40 in FIG. 1) to the calling party user equipment 12a and 12c, indicating to the calling parties 12a, 12c that the previously unavailable mobile called party user equipment 12b is now available to receive a call, wherein SMSC 30 sends Mobile Terminated Short Messages (MTSMs) 118 and 119 to the callers using the normal short message processing via the corresponding calling party MSCs 10a, 10c and associated base station systems 14a, 14c. Thus, when the called party mobile 12b transitions from “busy” to “idle”, the previously unsuccessful calling party subscribers 12a and 12c can then attempt to call MS2 12b, without having to waste time and resources on additional unsuccessful call attempts in the interim while the called party remained busy. In this scenario, moreover, if both callers 12a and 12c attempt a call right away, one may get through, and the other will find the called mobile 12b busy, whereby the above process is repeated, with the unsuccessful caller being provided with an announcement and a subsequent short message 40 as described supra.

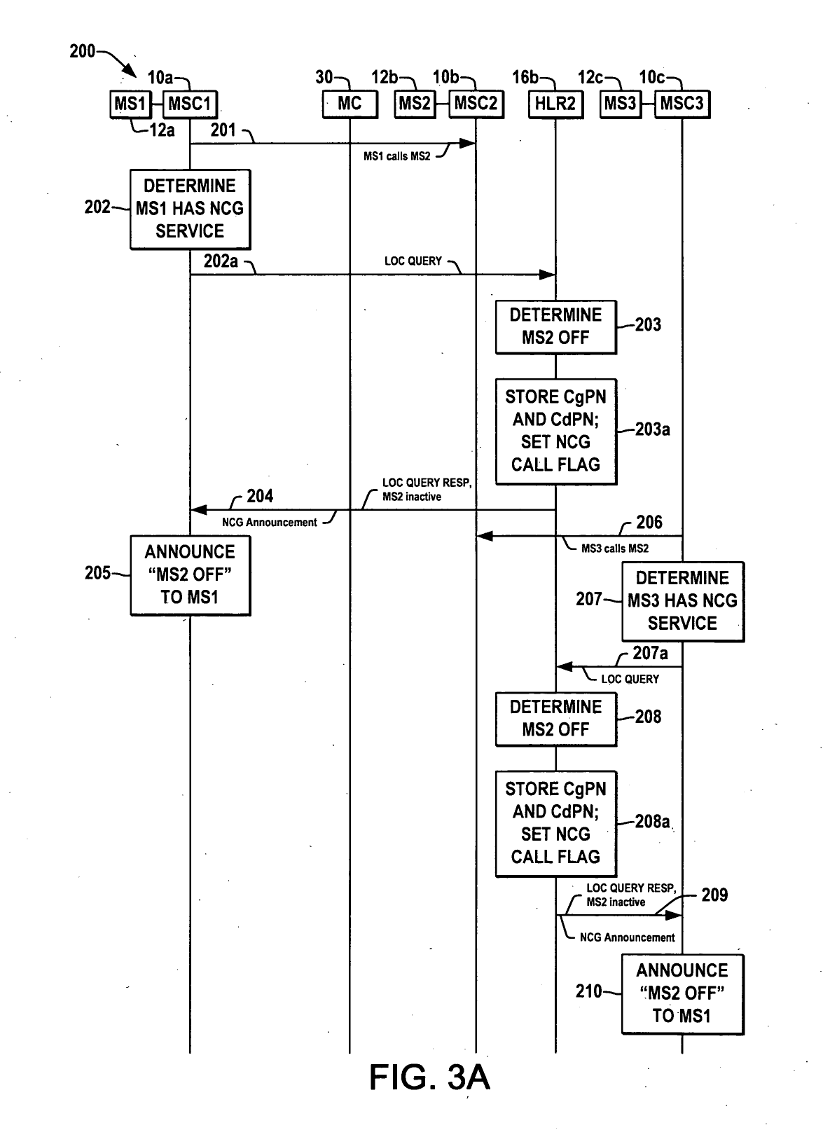

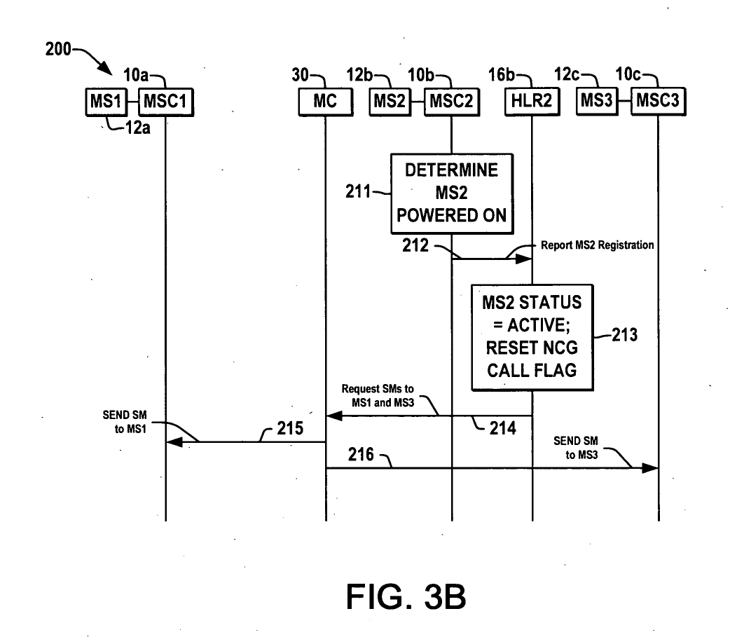

Referring now to FIGS. 1, 3A, and 3B, a similar service is provided to the calling subscribers 12a and 12c when the called party mobile 12b is powered down, as illustrated in a call flow diagram 200 beginning in FIG. 3A. With MS2 12b powered down, a first calling party mobile MS1 12a calls MS2 12b at 201, with the calling party's MSC1 10a determining at 202 that MS1 12a is a subscriber to the NCG service. At 202a, MSC1 10a sends a location query message to the called party HLR2 16b, which then determines at 203 that MS2 12b is off (powered down, out of range, etc.), stores the calling and called party numbers, and sets it's NCG call flag 24 at 203a. The called party HLR2 16b also sends a location request response at 204, which indicates to the MSC1 10a that MS2 12b is inactive, and also provides an NCG announcement that MSC1 10a plays for the caller 12a at 205 to indicate that MS2 12b is unavailable and a short message will be sent to the caller 12a when MS2 12b becomes available.

In this example, another prospective caller MS3 12c also makes an attempt to call MS2 12b at 206 (while MS2 12b remains powered down). The serving caller MSC3 10c determines at 207 that the caller subscribes to the NCG service and sends a location query message to the corresponding HLR3 16c at 207a. The HLR2 16b ascertains at 208 that the mobile MS2 12b is off and accordingly stores the calling and called party numbers and ensures that the NCG call flag 24 for MS2 12b is set at 208a (e.g., previously set in this example). The called party HLR2 16b responds to the location query at 209 indicating to the MSC3 10c that MS2 12b is inactive, and causes the MSC3 10c to play an announcement at 210 to the calling MS3 12c to notify the caller that MS2 12b is inactive and that a short message notification will be sent when MS2 12b becomes available. Continuing in FIG. 3B, sometime thereafter at 211, the called party MSC2 10b determines that the called MS2 12b has been powered on and has registered with the network, and MSC2 10b sends a report at 212 to the called party HLR2 16b reporting the registration. The HLR2 16b notes the active status of the mobile 12b at 213 and resets its NCG call flag 24. HLR 16b then sends one or more messages at 214 to the SMSC 30, whereupon SMSC 30 accordingly sends corresponding short messages 40 at 215 and 216 to the callers' user equipment 12a and 12c via the MSCs 10a and 10c and associated base station systems 14a and 14c, respectively. As with the above “busy-to-idle” example of FIGS. 2A and 2B, the exemplary processing for an unpowered mobile called party 12b in the call flow 200 facilitates the eventual connection of the calling parties 12a and 12c with the called party 12b when mobile 12b powers up and registers, without the NCG subscriber callers having to attempt unsuccessful call-backs, and without requiring call servers or other additional network elements or additional messaging.

While the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A calling party notification system for notifying a previously unsuccessful mobile calling party of a mobile called party's availability, comprising:
a short message service center operatively associated with a mobile calling party to provide short messages to a mobile calling party user equipment;
a called party home mobile switching element operatively associated with a mobile called party user equipment and operative to determine an availability status indicating whether the mobile called party user equipment is available to receive a call; and
a called party home location register operatively coupled with the called party home mobile switching element and with the short message service center, the called party home location register receiving an indication from the called party home mobile switching element that the previously unavailable mobile called party user equipment has become available to receive a call, and the called party home location register using the short message service center to initiate a short message to the calling party user equipment to notify the calling party that the previously unavailable mobile called party user equipment is available to receive a call.

2. The calling party notification system of claim 1, wherein the called party home location register receives a location query from a calling party mobile switching element for a call from the calling party to the called party, the location query indicating the calling party subscribes to a calling party notification service.

3. The calling party notification system of claim 2, wherein the called party home mobile switching element sends an unavailable indication to the called party home location register after an unsuccessful attempt to route the call to the mobile called party user equipment; and wherein in response to the unavailable indication from the called party home mobile switching element, the called party home location register requests that the called party home mobile switching element monitor the status of the mobile called party user equipment and report to the called party home location register when the mobile called party user equipment becomes available to receive a call.

4. The calling party notification system of claim 3, wherein the called party home location register sends an announcement to the calling party user equipment to notify the calling party that the called party user equipment is currently unavailable to receive a call and that the calling party will be sent a short message when the called party becomes available.

5. The calling party notification system of claim 1, wherein the called party home location register sends an announcement to the calling party user equipment to notify the calling party that the called party user equipment is currently unavailable to receive a call and that the calling party will be sent a short message when the called party becomes available.

6. The calling party notification system of claim 1, wherein the called party home mobile switching element is operative to determine whether the mobile called party user equipment is busy, idle, inactive, or active.

7. A mobile communications system, comprising:
a network;
a first mobile switching element operatively coupled with the network to provide communications service to mobile user equipment including a mobile calling party user equipment;
a first home location register operatively coupled with the first mobile switching element and with the network, the first home location register storing subscription information relating to the mobile calling party user equipment, the subscription information indicating that the mobile calling party user equipment subscribes to a calling part notification service;
a short message service center operatively coupled with the network and with the first mobile switching element to provide short messages to the mobile calling party user equipment;
a second mobile switching element operatively coupled with the network to provide communications service to mobile user equipment including a mobile called party user equipment, and operative to determine an availability status indicating whether the called party user equipment is available to receive a call; and
a second home location register operatively coupled with the second mobile switching element and with the short message service center, the second home location register receiving an indication from the second home mobile switching element that the previously unavailable called party user equipment has become available to receive a call, and the second home location register using the short message service center to initiate a short message to the calling party user equipment to notify the calling party that the previously unavailable called party user equipment is available to receive a call.

8. The mobile communications system of claim 7, wherein the first mobile switching element sends a location query to the second home location register indicating the calling party subscribes to a calling party notification service.

9. The mobile communications system of claim 8, wherein the second home mobile switching element sends an unavailable indication to the second home location register after an unsuccessful attempt to route the call to the mobile called party user equipment; and wherein in response to the unavailable indication from the second home mobile switching element, the second home location register requests that the second home mobile switching element monitor the status of the mobile called party user equipment and report to the second home location register when the mobile called party user equipment becomes available to receive a call.

10. The mobile communications system of claim 9, wherein the second home location register sends an announcement to the calling party user equipment to notify the calling party that the called party user equipment is currently unavailable to receive a call and that the calling party will be sent a short message when the called party becomes available.

11. The mobile communications system of claim 7, wherein the second home location register sends an announcement to the calling party user equipment to notify the calling party that the called party user equipment is currently unavailable to receive a call and that the calling party will be sent a short message when the called party becomes available.

12. The mobile communications system of claim 7, wherein the called party home mobile switching element is operative to determine whether the mobile called party user equipment is busy, idle, inactive, or active.

13. A method of notifying a previously unsuccessful mobile calling party of a mobile called party's availability, the method comprising:
monitoring the availability status of a previously unavailable mobile called party user equipment using a mobile switching element;
notifying a called party home location register that the previously unavailable called party user equipment has become available to receive a call; and
the called party home location register causing a short message to be sent to the calling party user equipment notifying the calling party that the previously unavailable called party user equipment is available to receive a call.

14. The method of claim 13, further comprising the called party home location register sending an announcement to the calling party user equipment notifying the calling party that the called party user equipment is currently unavailable to receive a call and that the calling party will be sent a short message when the called party becomes available.

15. The method of claim 13, further comprising the called party home location register receiving a location query from a calling party mobile switching element for a call from the calling party to the called party, the location query indicating the calling party subscribes to a calling party notification service.

16. The method of claim 15, further comprising:
the called party home mobile switching element sending an unavailable indication to the called party home location register after an unsuccessful attempt to route a call to the mobile called party user equipment; and
in response to the unavailable indication from the called party home mobile switching element, the called party home location register requesting that the called party home mobile switching element monitor the status of the mobile called party user equipment and report to the called party home location register when the mobile called party user equipment becomes available to receive a call.

17. The method of claim 16, further comprising the called party home location register sending an announcement to the calling party user equipment notifying the calling party that the called party user equipment is currently unavailable to receive a call and that the calling party will be sent a short message when the called party becomes available.

18. The method of claim 16, wherein sending an unavailable indication to the called party home location register comprises sending an indication to the called party home location register that the mobile called party user equipment is busy or inactive.

19. The method of claim 16, wherein notifying the called party home location register that the called party user equipment has become available comprises notifying the called party home location register that the called party user equipment is idle or active.

20. The method of claim 13, wherein notifying the called party home location register that the called party user equipment has become available comprises notifying the called party home location register that the called party user equipment is idle or active.
